(19) United States
(12) Patent Application Publication
(10) Pub. No.: US 2007/0099533 A1
(43) Pub. Date: May 3, 2007

(54) Multi-layered fire blocking fabric structure having augmented fire blocking performance and process for making same

(76) Inventor: Xun Ma, Midlothian, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/265,980

(22) Filed: Nov. 3, 2005

(51) Int. Cl. B32B 5/26; D04H 1/00; B32B 5/06

(52) U.S. Cl. 442/389; 442/414; 442/415; 428/920; 428/921

(57) ABSTRACT

This invention relates to a fire blocking structure containing in order a first fire barrier, a first heat absorber, a second fire barrier and optionally a second heat absorber.

### BACKGROUND OF THE INVENTION

1. Field of the Invention

This invention relates to a fire blocking fabric structure useful in fire blocking a mattress, mattress set, or an upholstered article and a process for making said fabric structure. This fabric structure can be used to construct mattresses and mattress sets having a peak heat release rate of less than 200 kilowatts within 30 minutes and a total heat release of less than 25 megajoules within 10 minutes when tested according to Technical Bulletin 603 of the State of California as revised November 2003.

2. Description of Related Art

The State of California has led the drive to regulate and reduce the flammability of mattresses and mattress sets in an attempt to reduce the number of lives lost in household, hotel, and institutional fires. In particular, the Bureau of Home Furnishings and Thermal Insulation of the Department of Consumer Affairs of the State of California issued Technical Bulletin 603 “Requirements and Test Procedure for Resistance of a Residential Mattress/Box Spring Set to a Large Open-Flame” to quantify the flammability performance of mattress sets.

United States Patent Application Publications 2004/0060119 & 2004/0060120 to Murphy et al. disclose a composite fire barrier fabric including a fire barrier layer and a thermally insulating layer wherein each layer is composed of a least one char-forming flame-retardant fiber. Char-forming flame-retardant fibers are desired in many fire blocking products because they generally perform better in fire barrier testing than either non-char forming fibers or thermoplastic fibers having chemical flame retardant treatments; however many such desired char-forming flame-retardant fibers are also very expensive and have other attributes, such as high modulus, which can detract from a textile-like material. Therefore, what is desired is to design a fire blocking fabric structure that utilizes a minimum amount of high performance, but expensive, structural char-forming flame retardant fibers and a maximum amount of lower thermal performance fibers that by their nature form substantially no structural char when burned. Further, what is especially desired is a fire blocking fabric structure design that uses such low fire performance fibers to augment the performance of high performance structural char-forming fibers.

### SUMMARY OF THE INVENTION

This invention relates to a fire blocking fabric structure, useful in at least a part of a mattress construction and comprising, in order, a first fire barrier fabric having a basis weight of at least 0.5 ounces per square yard and comprising at least one structural char-forming staple fiber; a first heat absorber containing substantially no structural char-forming staple fiber; a second fire barrier fabric comprising at least one structural char-forming staple fiber; and optionally, a second heat absorber containing substantially no structural char-forming staple fiber; wherein the ratio of the total basis weight of the fire barrier fabric in the structure to the total basis weight of the heat absorber in the structure is from 1:6 to 1:1, and wherein the structural char-forming staple fiber is a cellulosic fiber that retains at least 10 percent of its fiber weight when heated in air to 700° C. at a rate of 20 degrees C. per minute. Less that 25 percent of the fabric structure surface area has open cracks and gaps through the structure after impingement of the structure with a 2 cal/cm²/second (8.38 J/cm²/second) heat flux imposed on the fabric for 90 seconds, and after impingement, the amount of open cracks and gaps through the structure is less than that experienced by fabric structure having a fire impingement face of a single fire barrier having the same total weight of the first and second fire barrier fabrics combined and a single heat absorber having the same total weight of the first and optional second heat absorber combined, when impinged by an identical heat flux.

This invention also relates to a process for making a fire blocking fabric structure comprising, arranging in order,
(i) a first fire barrier fabric, comprising one or more layers and having a basis weight of at least 0.5 ounces per square yard and comprising at least one structural char-forming staple fiber,
(ii) a first heat absorber, comprising one or more layers and containing substantially no structural char-forming staple fiber,
(iii) a second fire barrier fabric, comprising one or more layers and comprising least one structural char-forming staple fiber, and
(iv) optionally, a second heat absorber, comprising one or more layers and containing substantially no structural char-forming staple fiber,
   and attaching the layers together to form a fabric structure; wherein the ratio of the total basis weight of the fire barrier fabric in the structure to the total basis weight of the heat absorber in the structure is from 1:6 to 1: 1, and the structural char-forming staple fiber is a cellulosic fiber that retains at least 10 percent of its fiber weight when heated in air to 700° C. at a rate of 20 degrees C. per minute.

### BRIEF DESCRIPTION OF FIGURES

FIG. 1 is simplified representation of one embodiment of the fire-blocked fabric structure of this invention having two fire barriers and one heat absorber.

FIG. 2 is a representation of a prior art fire-blocked fabric structure.

FIG. 3 is simplified representation of another embodiment of the fire-blocked fabric structure of this invention having two fire barriers and two heat absorbers.

FIG. 4 is a comparison of the fire-blocked fabric structure of this invention and the prior art fire-blocked fabric structure.

### DETAILS OF THE INVENTION

This invention relates to a fire blocking structure for mattresses and other upholstery wherein substantially non-char-forming fibers having no or meager flame retardancy are used to augment the performance of fire retardant char-forming fibers. The fire blocking fabric structure comprises, in order, a first fire barrier fabric having a basis weight of at least 0.5 ounces per square yard and comprising at least one structural char-forming fire-retardant staple fiber; a first heat absorber containing substantially no structural char-forming staple fiber; a second fire barrier fabric comprising at least one structural char-forming fire retardant staple fiber; and optionally, a second heat absorber containing substantially no structural char-forming staple fiber; wherein the structural char-forming staple fiber is a cellulosic fiber that retains at least 10 percent of its fiber weight when heated in air to 700° C. at a rate of 20 degrees C. per minute. In addition, the ratio of the total basis weight of the fire barrier fabric in the structure to the total basis weight of the heat absorber is from 1:6 to 1:1. Surprisingly, on an equal total weight basis, a three- or four-fabric structure, with alternating fire barriers and heat absorbers, performs better than a two-fabric structure having only one fire barrier and one heat absorber when impinged with an open flame. Less that 25 percent of the surface area of the fire blocking structure of this invention has open cracks and gaps through the structure after impingement of the structure with a 2 cal/cm²/second (8.38 J/cm²/second) heat flux imposed on the fabric for 90 seconds; and after impingement, the amount of open cracks and gaps through the structure is less than that experienced by fabric structure having a fire impingement face of a single fire barrier having the same total weight of the first and second fire barrier fabrics combined and a single heat absorber having the same total weight of the first and optional second heat absorber combined, when impinged by an identical heat flux.

Fire Barriers

The fire blocking structure of this invention comprises a first and second fire barrier, each fire barrier comprising one or more layers and comprising at least one structural char-forming fire retardant staple fiber that is a cellulose fiber that retains at least 10 percent of its fiber weight when heated in air to 700° C. at a rate of 20 degrees C. per minute. Each first fire barrier serves as the first flame contact layer or first flame impingement surface for the fire blocking structure and in addition has a total basis weight of at least 0.5 ounces per square yard (17 grams per square meter). A first fire barrier having a lower basis weight is believed to not provide adequate impingement protection for the fire blocking structure. In one preferred embodiment, the fire barrier material is equally distributed in the structure; that is, the first and second fire barriers have equal basis weight. In another preferred embodiment, the first fire barrier layer, on which the flame first impinges, has more fire barrier material.

One embodiment of a preferred fire barrier is a single layer nonwoven fabric. The total weight of each fire barrier is preferably from 0.5 to 3 ounces per square yard (17 to 102 grams per square meter). Heavier weight fabrics still provide protection, however, with additional basis weight the total fabric structure becomes more difficult to handle, sew, and incorporate into a mattress or upholstery.

The nonwoven fabric useful in the first and second fire barriers can be made by conventional nonwoven sheet forming processes, including processes for making air-laid nonwovens, wet-laid nonwovens, or nonwovens made from carding equipment; and such formed sheets can be consolidated into fabrics via spunlacing, hydrolacing, needlepunching, or other processes which can generate a nonwoven sheet. The spunlaced processes disclosed in U.S. Pat. No. 3,508,308 and U.S. Pat. No. 3, 797,074; and the needlepunching processes disclosed in U.S. Pat. No. 2,910,763 and U.S. Pat. No. 3,684,284 are examples of methods well known in the art that are useful in the manufacture of the nonwoven fabrics. The preferred nonwoven fabrics are made from one or more air-laid or carded webs; in a most preferred embodiment the webs contain a binder and the webs are then thermally bonded to form nonwoven sheets having adequate durability to be used in a mattress or other article.

The structural char-forming fire retardant fiber useful in the fire barrier of this invention is a char-forming cellulose fiber having a limiting oxygen index (LOI) of greater than 21. By “structural char-forming”, it is meant the cellulose fiber retains at least 10 percent of its weight when heated in air to 700° C. at a rate of 20 degrees C. per minute. Such cellulose fibers preferably have 10 percent inorganic compounds incorporated into the fibers. Such fibers, and methods for making such fibers, are generally disclosed in U.S. Pat. No. 3,565,749 and in British Pat. No. GB 1,064,271. A preferred structural char-forming cellulose fiber for this invention is a viscose fiber containing hydrated silicon dioxide in the form of a polysilicic acid with aluminum silicate sites. Such fibers, and methods for making such fibers are generally disclosed in U.S. Pat. No. 5,417,752 and PCT Pat. Appl. WO9217629. Viscose fiber containing silicic acid and having approximately 31 (±3) percent inorganic material is sold under the trademark Visil® by Sateri Oy Company of Finland. The nonwoven fabric containing structural char-forming fibers provides fire-blocking performance without the need for the fabric to be treated with additional flame-retardant additives or topically-applied flame retardant compounds.

In a preferred embodiment, the fire barrier also comprises a heat resistant fiber. By “heat resistant fiber” it is meant that the fiber preferably retains 90 percent of its fiber weight when heated in air to 500° C. at a rate of 20 degrees C. per minute. Such fiber is normally flame resistant, meaning the fiber or a fabric made from the fiber has a Limiting Oxygen Index (LOI) such that the fiber or fabric will not support a flame in air, the preferred LOI range being about 26 and higher. The preferred fibers do not excessively shrink when exposed to a flame, that is, the length of the fiber will not significantly shorten when exposed to flame. Fabrics containing an organic fiber that retains 90 percent of its fiber weight when heated in air to 500° C. at a rate of 20 degrees C. per minute tend to have limited amount of cracks and openings through the fabric when burned by an impinging flame, which is important to the fabric's performance as a fire blocker.

Heat resistant and stable fibers useful in the reinforced nonwoven fire-blocking fabric of this invention include fiber made from para-aramid, polybenzazole, polybenzimidazole, or polyimide polymer. The preferred heat resistant fiber is made from aramid polymer, especially para-aramid polymer.

As used herein, “aramid” is meant a polyamide wherein at least 85% of the amide (—CONH—) linkages are attached directly to two aromatic rings. “Para-aramid” means the two rings or radicals are para oriented with respect to each other along the molecular chain. Additives can be used with the aramid. In fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the preferred para-aramid is poly(paraphenylene terephthalamide). Methods for making para-aramid fibers useful in this invention are generally disclosed in, for example, U.S. Pat. Nos. 3,869,430, 3,869,429, and 3,767,756. Such aromatic polyamide organic fibers and various forms of these fibers are available from DuPont Company, Wilmington, Del. under the trademark Kevlar® fibers. Other fibers useful in this invention are polyoxadiazole fiber known as Oxalon® and polypyridobisimidazole fiber known as M5®.

Commercially available polybenzazole fibers useful in this invention include Zylon® PBO-AS (Poly(p-phenylene-2,6-benzobisoxazole) fiber, Zylon® PBO-HM (Poly(p-phenylene-2,6-benzobisoxazole)) fiber, available from Toyobo, Japan. Commercially available polybenzimidazole fibers useful in this invention include PBI® fiber available from Celanese Acetate LLC. Commercially available polyimide fibers useful in this invention include P-84® fiber available from LaPlace Chemical.

Heat Absorbers

The fire blocking structure of this invention further comprises a first and optionally a second heat absorber, each heat absorber comprising one or more layers and containing substantially no structural char-forming staple fiber. Each first and optional second heat absorber can be made from multiple layers of nonwoven material, but in a preferred embodiment are each a single layer of material. The total weight of each heat absorber is preferably from 2 to 6 ounces per square yard (68 to 204 grams per square meter). Heavier weight fabrics may still provide protection, however, with additional basis weight the total fabric structure becomes more difficult to handle, sew, and incorporate into a mattress or upholstery. In one most preferred embodiment, each heat absorber is a single-layer, bulky needle-punched nonwoven fabric having a basis weight of about 4 to 6 ounces per square yard (136 to 204 grams per square meter), and a bulk density of 20 to 64 kilograms per cubic meter.

The nonwoven fabric useful in the first and optional second heat absorbers can be made by the same conventional nonwoven sheet forming processes that can be used to make the fire barriers used in this invention. In one preferred embodiment the nonwoven fabrics used as a heat absorber are battings comprising a substantial amount of non-flammable or less-flammable materials. Preferably such battings are needlepunched to provide the battings with some mechanical stability so they can be handled and processed easily.

In another embodiment of this invention, the first or optional second heat absorber comprises cotton fiber. Surprisingly, when the fire blocking fabric structure of this invention is made as described herein, it is not necessary that the cotton used in the heat absorber be treated for flame retardancy, and non-treated cotton is preferred since such treatment requires the addition of flame retardant chemicals to the cotton, and such treatments may not be durable and may impart stiffness to the cotton.

In other embodiment of this invention, the first or optional second heat absorber comprises polyester fiber, preferably flame retardant (FR) polyester fiber having spun-in flame retardant chemicals or compounds. Such FR polyester fiber, while having some flame retardancy, typically shrinks dramatically in contact with flame and will melt and burn, and therefore has only meager flame retardant performance when compared with fibers made from inherently flame retardant or heat resistant polymers, which generally do not excessively shrink or melt in flame.

Other fibers useful in the heat absorber of this invention are sheath-core fibers where the sheath polymer has higher LOI. In some embodiments such fibers utilize sheath polymers such as polyesters having spun in FR chemicals; polyphenylene sulfide; liquid crystalline polyesters; melt-processable fluoro-polymers; polysulfones such as polyphenyl sulfone and polyether sulfone; and polyetherimides. The core of such sheath-core fibers preferably utilizes polyester polymer(s).

Fire Blocking Structure

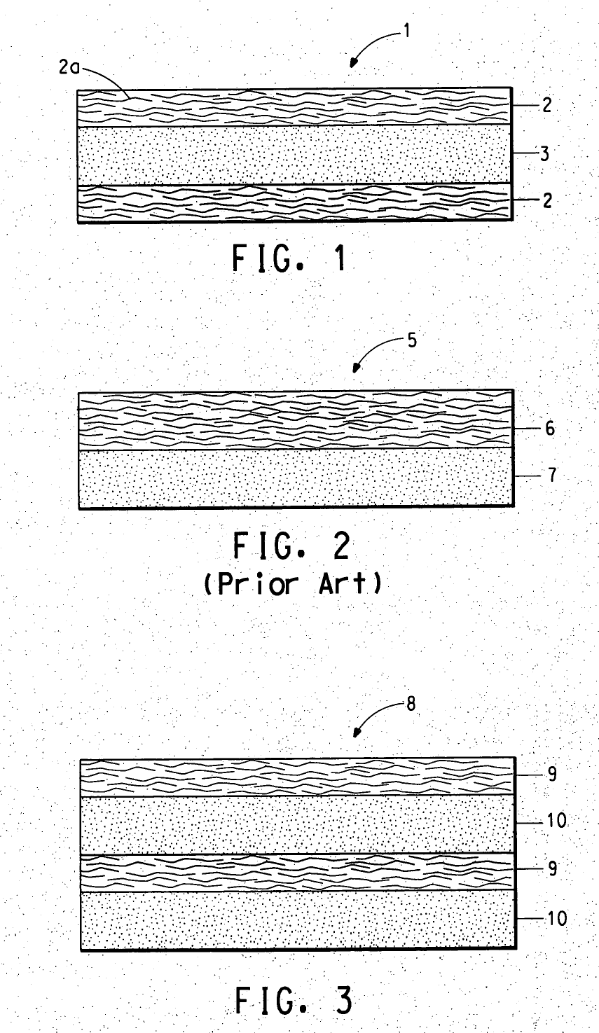

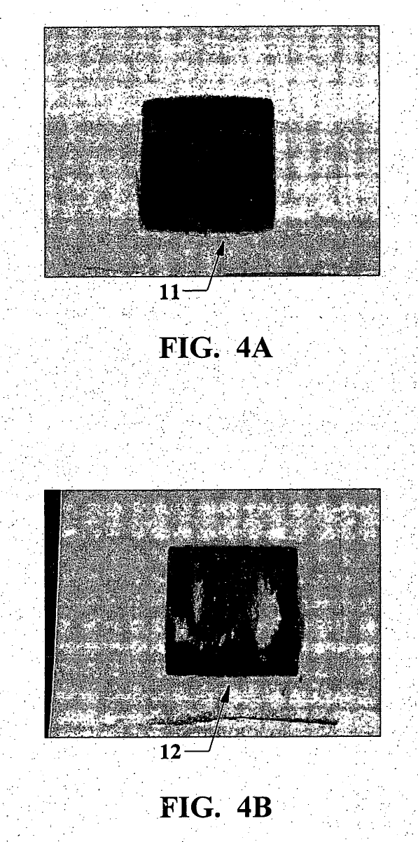

The fire blocking structure of this invention requires at least two fire barriers, one of which is the flame impingement face, and one first heat absorber positioned between the two fire barriers. This three component structure functions better when impinged by an open flame than a two component structure of only one fire barrier and one heat absorber, even if the structures have identical weights and the amount of fire barrier material is the same in both structures. FIG. 1 illustrates one embodiment of the fire blocking structure of this invention. Fire blocking fabric structure 1 is shown with two fire barriers 2 sandwiching a heat absorber 3. Fire barrier 2a is the flame impingement fire barrier. FIG. 2 illustrates a fire blocking fabric structure of the prior art 5 having one fire barrier 6 and one heat absorber 7. Fire barrier 6 is the flame impingement layer for this structure. The surprising fact is that the two layer structure 5 of the prior art functions worse that the inventive structure 1 despite having a flame impingement fire barrier 6 of a higher weight than the impingement fire barrier 2a.

In the fire blocking structure of this invention, the ratio of the total basis weight of the first and second fire barriers to the total basis weight of the first and optional second heat absorbers in the fire blocking structure is from 1:6 to 1:1. It is thought that within the structures useful in mattresses and upholstery, a fire barrier to heat absorber ratio lower than 1:6 creates a situation wherein there is simply too much fuel provided by the heat absorber, and therefore the amount of heat generated by the burning of the heat absorber overwhelms the functioning of the second fire barrier. Fabric structures where there is more fire barrier material than heat absorber, while clearly useful, generally are too expensive to be of practical use.

When the fire blocking structure of this invention is impinged with a flame, the first fire barrier, the flame impingement face, receives the full force of the flame jet and attempts to prevent the flame from penetrating deeper into the structure. Therefore, it is not unusual for the first fire barrier to be substantially damaged and penetrated by the flame despite containing structural char-forming fiber. However, in a preferred embodiment of the fire blocking structure of this invention the structural char-forming fiber of the second fire barrier remains substantially intact with few gaps cracks or openings through the structure after the fire blocking structure has been impinged by the flame.

While this invention should not be limited by the proposed mechanism, it is believed that because the heat absorber does not contain substantial amounts of char forming fiber, the heat absorber may perform two functions when a flame comes in contact with it through the first fire barrier. The degree in which the functions predominate is believed to be dependent on the type of fiber used in the heat absorber; however, it is believed that the heat absorber performs both functions when burned.

It is believed the first function of the heat absorber is to distribute the heat from any flames that penetrate the fire barrier layer over a wider area and/or absorbing that heat in a phase change. This is particularly important when the heat absorber contains a thermoplastic fiber, which can shrink away from and/or melt from contact with the flame. This redistribution of localized heat and/or the reduction of heat therefore improves the function of the second fire barrier layer because the amount or intensity of heat it receives is lessened.

It is believed the second function of the heat absorber is as an oxygen-depleting layer for the fire blocking structure. This is particularly important when the heat absorber contains fiber that burns readily in air, such as cotton fiber. The materials in the heat absorber burn and consume the oxygen that is present in the structure, particularly oxygen that is present at the interface between the first heat absorber and the second fire barrier. By reducing the amount of oxygen available to the second fire barrier in the fire blocking structure, the first heat absorber actually makes the second fire barrier more flame retardant, thereby augmenting the performance of the fire blocking structure.

After a sample of the fire blocking structure of this invention is tested for Thermal Performance Temperature using the same instrument that is used for the NFPA1971 Standard on Protective Ensemble for Structural Fire Fighting 2000 Edition Section 6-10, less that 25 percent of the structure surface area has open cracks and gaps through the structure. The test requires impingement of the structure with a flame contributing a 2 cal/cm²/second (8.38 J/cm²/second) heat flux that is imposed on the fabric for 90 seconds. The fabric structure is positioned so that during the test the outer surface of the structure closest to the heat flux or flame is a fire barrier layer in the fabric structure. In a preferred embodiment, less that 15 percent of the structure surface area has open cracks and gaps through the structure after testing, and in a most preferred embodiment, less than 5 percent of the structure surface area has open cracks and gaps through the structure after testing. The term “cracks and gaps” is meant to represent the openings through the fabric and represent a continuum of possible openings. “Cracks” are meant to describe thin crack-like openings through the structure after testing, while “gaps” are meant to describe any other larger gaping or open holes through the structure after testing. The amount of surface area with gaps through the structure can be determined by simply measuring the open area (the cracks and gaping holes or gaps through the structure from one side to the other) in the sample after burning.

Surprisingly, on an equal total weight basis, the fire blocking structure of this invention, with multiple alternating fire barriers and heat absorbers, performs better than a two-fabric structure having only one fire barrier and one heat absorber when impinged with an open flame. That is, after impingement by identical heat fluxes, the amount of sample surface area having open cracks and gaps through the structure developed by the fire blocking structure of this invention, having at least a first and second fire barrier, and at least one, and optionally two heat absorbers, is less than the amount of sample surface area having open cracks and gaps through the structure developed by a comparison structure having a fire impingement face of a single fire barrier, with this single fire barrier having the same total weight of the first and second fire barriers combined, and a single heat absorber, this single heat absorber having the same total weight of the first and optional second heat absorber(s) combined.

In one embodiment, the total basis weight of the fire blocking structure of this invention is from 4 to 12 ounces per square yard (136 to 408 grams per square meter). For many typical mattress designs, a structure having a lower basis weight is not as desirable due to the lower level of fire blocking it provides. Structures having a higher basis weight are less desirable because the heavy material would difficult to handle in typical manufacturing steps used in many mattress and upholstery applications. Preferably, the fire blocking structure of this invention has a total basis weight of from 6 to 10 ounces per square yard (204 to 340 grams per square meter).

The fire blocking structure of this invention can further comprise an optional second heat absorber arranged on the other side of the second fire barrier. FIG. 3 illustrates a fire blocking structure 8 having two fire barriers 9 and two heat absorbers 10. The second heat absorber is useful when additional thermal insulation is desired for the structure to prevent conduction of the heat seen by the second fire barrier to points deeper in the mattress. When this fire blocking structure is used, the outer fire barrier is the flame impingement face for the structure.

While the fire blocking structure of this invention is useful in most mattress and upholstery applications, additional fire barriers or heat absorbers or other material may be combined with the structure if desired.

Process

One embodiment of this invention is a process for making a fireblocking fabric structure comprising:
a) arranging, in order,
   (i) a first fire barrier fabric, comprising one or more layers and having a basis weight of at least 0.5 ounces per square yard and comprising at least one structural char-forming staple fiber,
   (ii) a first heat absorber, comprising one or more layers and containing substantially no structural char-forming staple fiber,
   (iii) a second fire barrier fabric, comprising one or more layers and comprising least one structural char-forming staple fiber, and
   (iv) optionally, a second heat absorber, comprising one or more layers and containing substantially no structural char-forming staple fiber,
      wherein the ratio of the total basis weight of the fire barrier fabric in the structure to the total basis weight of the heat absorber in the structure is from 1:6 to 1:1, and the basis weight of the first fire barrier fabric is greater than, less than or equal to the basis weight of any additional fire barrier fabric in the structure, and
      wherein the structural char-forming staple fiber is a cellulosic fiber that retains at least 10 percent of its fiber weight when heated in air to 700° C. at a rate of 20 degrees C. per minute, and
b) attaching the layers together to form a fabric structure.

The arranging and attaching of the fire barriers and the heat absorber(s) can be accomplished in a batch process or in a continuous process. For example, one embodiment of a batch arranging process involves laying out on a table or other suitable flat surface a length of the first fire barrier fabric, and then laying a first heat absorber on top of the fire barrier fabric, followed by a layer of the second fire barrier fabric, and then adding, if desired, the optional second heat absorber. Adhesive can be applied to the various layers as they are laid down, preferably by a light spray; or if desired, the layers can be stitched or thermally bonded after the layers are assembled.

In a preferred embodiment, the arranging and attaching of the fire barrier fabrics and heat absorber fabric(s) is accomplished in a continuous process. The continuous process can involve simultaneously or sequentially combining layers of materials, which can be obtained from rolls, assembling the appropriate fire or heat absorber as required in the proper order. Adhesive spray can be applied between the layers, or alternatively, the entire structure can be stitched with thread, preferably a heat resistant thread such as a thread made from polyparaphenylene terephthalamide fiber, preferably the thread known to contain Kevlar® fiber.

In another embodiment, the entire structure can be thermally bonded using a set of calender rolls, an oven, or some combination of the two. Alternatively, if desired the structure can be point-bonded, for example, by using an embossed calender roll; or can be ultrasonically seamed, such as with in a quilt pattern. A further alternative method of attaching the layers is by needle-punching the layers together.

The fire blocking structure of this invention can be incorporated mattresses, foundations, and/or box springs as a fire blocking layer. For example, the panels and the borders of mattresses, foundations, and/or box springs can utilize the previously described fabric structure or any other variant that incorporates as a component the fire blocking structure of this invention. In a most preferred embodiment, mattress sets of this invention have a peak heat release of less than 200 kilowatts within the first 30 minutes of the test, and preferably within the first 60 minutes of the test, when tested according to Technical Bulletin 603 of the State of California as revised November 2003. Additionally, mattresses of this invention may have a total heat release of less than 25 megajoules within 10 minutes when tested according to this technical bulletin.

### Test Methods

ThermoGravametric Analysis. The fibers used in this invention retain a portion of their fiber weight when heated to high temperature at a specific heating rate. This fiber weight was measured using a Model 2950 Thermogravimetric Analyzer (TGA) available from TA Instruments (a division of Waters Corporation) of Newark, Del. The TGA gives a scan of sample weight loss versus increasing temperature. Using the TA Universal Analysis program, percent weight loss can be measured at any recorded temperature. The program profile consists of equilibrating the sample to 50 degrees C., placing the sample in a 500 microliter ceramic cup (PN 952018.910) sample container and ramping the temperature of the air, as measured by a thermocouple placed directly above the lip of the sample container, at 20 degrees C. per minute from 50 to 1000 degrees C., using air supplied at 10 ml/minute. The testing procedure is as follows. The TGA was programmed using the TGA screen on the TA Systems 2900 Controller. The sample ID was entered and the planned temperature ramp program of 20 degrees per minute selected. The empty sample cup was tared using the tare function of the instrument. The fiber sample was cut into approximately 1/16″ (0.16 cm) lengths and the sample pan was loosely filled with the sample. The sample weight should be in the range of 120 to 60 mg. The TGA has a balance therefore the exact weight does not have to be determined beforehand. None of the sample should be outside the pan. The filled sample pan was loaded onto the balance wire making sure the thermocouple is close to the top edge of the pan but not touching it. The furnace is raised over the pan and the TGA is started. Once the program is complete, the TGA will automatically lower the furnace, remove the sample pan, and go into a cool down mode. The TA Systems 2900 Universal Analysis program is then used to analyze and produce the TGA scan for percent weight loss over the range of temperatures.

Thickness. Thickness of the layered batting was measured using ASTM D5736-95 (Reapproved 2001).

Thermal Performance Temperature. The thermal insulating properties of these properties at high temperatures and heat fluxes was then measured using the same instrument that is used for the NFPA1971 Standard on Protective Ensemble for Structural Fire Fighting 2000 Edition Section 6-10. In order to characterize the materials of this invention, the instrument was operated in a data acquisition mode. A 2 cal/cm²/second (8.38 J/cm²/second) heat flux was imposed on the fabric structure for 90 seconds. The fabric structure is positioned so that during the test the outer surface of the structure closest to the heat flux or flame is a fire barrier layer in the fabric structure. During this time, the heat passing through the materials was measured using a calorimeter placed in direct contact with the back face (base layer) of the specimen. The materials were characterized in terms of the temperature of the calorimeter thermocouple at the end of the 90 seconds exposure. This value is directly proportional to the amount of heat that passed through the barrier fabric.

Basis Weight. Basis weight of the batting was measured using ASTM D6242-98.

### EXAMPLES

### Example 1

A fire blocking fabric structure of this invention and a comparison fabric structure were made, each fabric structure having a total basis weight of about 7 ounces per square yard and each fabric structure having 1 total ounce per square yard of fire barrier and 6 total ounces per square yard of heat absorber. The fire blocking fabric structure of this invention had three layers, the three layers being one 6-oz/yd² heat absorber layer sandwiched between two 0.5 oz/yd² fire barrier layers. The comparison fabric structure had two layers, with a 1.0-oz/yd² fire barrier layer on top of a 6-oz/yd² heat absorber layer.

The fire barrier layers were prepared as follows. Approximately 37.5 parts by weight 2.2 dpf, 2″ cut length Type 970 Kevlar® brand staple fiber, approximately 37.5 parts by weight 3.5 dpf, 2″ cut length Visil® 33AP staple fiber and approximately 25 parts 4 dpf, 2″ cut length Type 4080 Unitika binder fiber were blended as fed from bales to three cards and fiber webs from the three cards were collected on a transporting belt. Two fire barriers having differing basis weights were made in this manner, in successive runs, with the speed of the transporting belt being adjusted as necessary to create sheets having a basis weight of approximately 0.5 oz/yd² and 1.0 oz/yd². After formation of the sheet, it was conveyed through an oven at 285° C. to activate the binder fiber. At the oven exit the sheet was compressed between two steel rolls with 0″ gap, which consolidated the components into a cohesive fabric. The fabric then cooled in this compressed state and was then used as 0.5 and 1.0-oz/yd² fire barriers mentioned previously. The final composition of the fire barrier layer was approximately 37.5% by weight Kevlar®) fiber, 37.5% by weight Visil® fiber, and 25% by weight binder.

The heat absorber was a spunbonded sheet made from flame-retardant polyethylene terephthalate (FR PET) melt-spun fibers and were made in a similar manner to the bicomponent sheath-core fibers of the fire barrier except the same polymer was used for both the sheath and the core components. The FR PET polymer was first dried in through-air dryers at an air temperature of 120° C. until the polymer had a moisture content of less than 50 ppm. The dried polymer was then heated to 290° C. in two separate extruders. The heated polymer was then extruded and metered to a spin-pack assembly, where the two melt streams were separately filtered and then combined through a stack of distribution plates to provide 14 rows of concentric sheath-core fiber cross-sections. The spin-pack assembly was heated to 295° C. and each of the capillaries had a maximum diameter of 0.35 mm. The polymers were extruded through each of the capillaries forming streams of polymer that were cooled and attenuated into a bundle of fibers with additional air supplied from a rectangular slot jet located 38 cm from the spin-pack surface. The fibers existing the jet were collected as a web on a forming belt, with vacuum applied underneath the belt to help pin the web of fibers. The web of fibers was then thermally bonded between a set of heated rolls. The bonding conditions were 135° C. roll temperature and 200 pounds per linear inch nip pressure. The forming belt speed was adjusted to yield nonwoven sheets having basis weight ranging from 2 oz/yd² to 6 oz/yd².

The fire blocking fabric structure of this invention and the comparison fabric structure were then tested for performance in the TPT test using a 90 second exposure at 2 cal/cm²-s with no spacer. The samples were arranged so that flame impinged on one side; in the case of the structure of this invention the flame impinged on one of the 0.5-oz/yd² fire barrier layers and the flame impinged on the 1.0-oz/yd² fire barrier layer for the comparison. FIG. 3 illustrates the result of the test, with the picture showing the flame impingement side, or the side directly over the flame, of the samples tested. The fire blocking fabric structure of this invention 11 showed essentially no break open or penetration of the flames through the structure while the comparison fabric 12 showed excessive break open and gaps through the structure where the flames had penetrated through the structure, despite the fact the flame impinged on a higher basis weight fire barrier on the strike face of comparison fabric 12 and the total amount of material in both samples was the same.

### Example 2

A fire blocking fabric structure having a total basis weight of about 8 ounces per square yard and having two fire barriers and two heat absorbers was prepared as follows.

Each of the fire barriers were identical and contained 40 parts by weight 3.5 dpf Type 33AP Visil® cellulose fiber (available from Sateri) having an average cut length of 50 mm, 40 parts by weight 7 dpf Protex C modacrylic fiber (available from Kaneka) having an average cut length of 51 mm, and 20 parts by weight 4 dpf Type 4080 Unitika polyester binder fiber having an average 2″ cut length. To make the fire barriers, the cellulose, modacrylic, and binder fibers were fed from bales, blended, and then fed to three cards where the fibers were formed into blended fiber webs. The fiber webs from the three cards were collected, one on top of the other, on a transporting belt. The collected fiber webs were then conveyed through an oven at 285° C. to activate the binder fiber. At the oven exit the collected fiber webs were compressed between two steel rolls with a 0″ gap, which consolidated the fibers and binder into a cohesive fabric. The fabric was then cooled in this compressed state and was then used as a 2.0 oz/yd² fire barrier. The total amount of fire barrier material in the fire blocking structure was about 4 oz/yd².

The fire blocking structure also contained two heat absorbers, each of which was a spunbonded sheet made from melt-spun bicomponent fibers comprising a poly(phenylene sulfide) polymer (PPS, available from Ticona) as the sheath component and flame retardant (FR) poly(ethylene terephthalate) polymer (FR PET, available from Santai Company of China) as the core component.

The spunbonded sheet were made using conventional spunbonded equipment using sheath/core spinnerets. Specifically, PPS polymer and FR PET polymer were first dried in separate through-air dryers at an air temperature of 120° C. until the polymers had a moisture content of less than 50 ppm. The dried polymer was then heated in separate extruders, with the PPS polymer being heated to 300° C. and the FR PET polymer being heated to 290° C. The two polymers were separately extruded and metered to a spin-pack assembly, where the two melt streams were separately filtered and then combined through a stack of distribution plates to provide 14 rows of concentric sheath-core fiber cross-sections. The spin-pack assembly was heated to 300° C. and each of the capillaries had a maximum diameter of 0.35 mm. The polymers were extruded through each capillary, forming streams of polymer that were cooled and attenuated into a bundle of fibers with additional air supplied from a rectangular slot jet located 38 cm from the spin-pack surface. The fibers exiting the jet were collected as a web on a forming belt, with vacuum applied underneath the belt to help pin the web of fibers. The web of fibers was then thermally bonded between a set of heated rolls. The forming belt speed was adjusted to yield a nonwoven sheet having a basis weight of about 2 oz/yd².

The fire blocking fabric structure was assembled by stacking one of the two layers of heat absorber onto one of the two layers of fire barrier, and applying an adhesive spray at the edges of the fabric to stick the two layers together. The second of the two fire barrier layers was then stacked (and adhered, again at the edges, using the adhesive spray) onto the first heat absorber layer. The remaining heat absorber layer was then stacked (and adhered, again at the edges, using the adhesive spray) onto the second fire barrier layer. The result was a 4-layer fire blocking structure having a total basis weight of 8 oz/yd² and having alternating fire barrier and heat absorbing layers, each of the 4 layers having a basis weight of 2 oz/yd².

The fire barrier fabric structure was then integrated into a single-sided mattress and tested for open flame test protocol TB 603. The top panel of the mattress was quilted with ¾″ polyester batting beneath the ticking, under which was placed the fire blocking structure. The border of the mattress had a layer of 3/16″ foam under the ticking, under which was placed the fire blocking structure. Two mattresses were made in this manner and they were tested according to Technical Bulletin 603 of the State of California, as revised November 2003. Composition details and test results are reported in Table 1. The mattress had an average peak heat release rate of 32 kilowatts within 30 minutes and an average total heat release of 4 megajoules, which was well within the TB 603 requirement of less than 200 kilowatts within 30 minutes and a total heat release of less than 25 megajoules within 10 minutes.

### Example 3

Example 2 was repeated to make a fire blocking structure having the same construction and the same fire barrier, heat absorber, and total basis weight as Example 2, however, a layer of 100% spunbonded FR PET was used for each of the two heat absorber layers. The fire barrier fabric structure was then integrated into single-sided mattresses identical to Example 2 and tested for open flame test protocol TB 603 as before. Composition details and test results are reported in Table 1. The mattress had an average peak heat release rate of 34 kilowatts within 30 minutes and an average total heat release of less than 5 megajoules within 10 minutes, and therefore passed the test.

TABLE I

| Layer | Item | Ex. 2 | Ex. 3 |
|---|---|---|---|
| 1st Layer | Basis Weight | 2 | 2 |
| (First Fire Barrier) | oz/yd² | | |
| | (g/m²) | ( ) | ( ) |
| | Visil ® (wt %) | 37.5 | 37.5 |
| | Modacrylic (wt | 37.5 | 37.5 |
| | %) | | |
| | binder (wt %) | 25 | 25 |
| 2nd Layer | Basis Weight | 2 | 2 |
| (First Heat | oz/yd² | | |
| Absorber) | (g/m²) | | |
| | PPS (wt %) | 50 | 0 |
| | FR PET (wt %) | 50 | 100 |
| 3rd Layer | Basis Weight | 2 | 2 |
| (Second Fire | oz/yd² | | |
| Barrier) | (g/m²) | ( ) | ( ) |
| | Visil ® (wt %) | 37.5 | 37.5 |
| | Modacrylic (wt | 37.5 | 37.5 |
| | %) | | |
| | binder (wt %) | 25 | 25 |
| 4th layer | Basis Weight | 2 | 2 |
| (Second Heat | oz/yd² | | |
| Absorber) | (g/m²) | ( ) | ( ) |
| | PPS (wt %) | 50 | 0 |
| | FR PET (wt %) | 50 | 100 |
| Peak Heat Release | Mattress 1 | 27 | 32 |
| (kW) | Mattress 2 | 37 | 35 |
| | Average | 32 | 34 |
| Total Heat Release | Mattress 1 | 2 | 4 |
| (MJ) | Mattress 2 | 6 | 5 |
| | Average | 4 | 5 |

### Example 4

Fire blocking fabric structures, having total basis weights ranging from 4 to 7 ounces per square yard, two fire barrier layers and one heat absorber layer, and designated as Items 1-7 in Table 2, were prepared as follows.

Each fire barrier layer was the same as and made in the same manner as in Example 1. contained 40 parts by weight 3.5 dpf Type 33AP Visil® cellulose fiber (available The heat absorber layer were commercially available 100% cotton battings typically used for crafts and quilting, and depending on the final Item, had a basis weight of from about 3 to 5 oz/yd².

Fire blocking fabric structures designated Items 1-7 were then assembled by sandwiching a heat absorber layer between two fire barrier layers held in place by two metal plates. The fire blocking fabric structures were then tested for their thermal protective performance (TPT). The test items and the final temperature were shown in Table 2. All of these items had TPT temperatures of less than 400° C., which is believed to be critical for passage of TB 603.

TABLE 2

| | Item | 1 | 2 | 3 | 4 | 5 | 6 | 7 |
|---|---|---|---|---|---|---|---|---|
| 1^{st} layer | BW (osy)¹ | 0.5 | 0.5 | 1 | 1 | 0.75 | 0.5 | 1 |
| | Visil ®² | 37.5 | 37.5 | 37.5 | 37.5 | 37.5 | 37.5 | 37.5 |
| | Kevlar ®³ | 37.5 | 37.5 | 37.5 | 37.5 | 37.5 | 37.5 | 37.5 |
| | binder² | 25 | 25 | 25 | 25 | 25 | 25 | 25 |
| 2^{nd} layer | BW (osy) | 3 | 5 | 3 | 5 | 3 | 3 | 3 |
| | Cotton⁴ | 100 | 100 | 100 | 100 | 100 | 100 | 100 |
| 3^{rd} layer | BW (osy) | 0.5 | 0.5 | 1 | 1 | 0.75 | 1 | 0.5 |
| | Visil | 37.5 | 37.5 | 37.5 | 37.5 | 37.5 | 37.5 | 37.5 |
| | Kevlar | 37.5 | 37.5 | 37.5 | 37.5 | 37.5 | 37.5 | 37.5 |
| | binder | 25 | 25 | 25 | 25 | 25 | 25 | 25 |
| | Total BW (osy) | 4.0 | 6.0 | 5.0 | 7.0 | 4.5 | 4.5 | 4.5 |
| | Final Temperature (° C.) | 363 | 317 | 290 | 254 | 341 | 334 | 312 |

### Example 5

Fire blocking fabric structures designated as Items 8-13 in Table 3, having total basis weights ranging from 4 to 7 ounces per square yard, and made with two fire barrier layers and one heat absorber layer were prepared as follows.

Each fire barrier layer was the same as in Example 2. The heat absorber was the same as Example 4. Fire blocking fabric structures were then assembled as in Example 4 and the fire blocking fabric structures were then tested for their thermal protective performance (TPT). The test items and the final temperature were shown in Table 3. All of these items had TPT temperatures of less than 400° C., which is believed to be critical for passage of TB 603.

TABLE 3

| | Item | 8 | 9 | 10 | 11 | 12 | 13 |
|---|---|---|---|---|---|---|---|
| 1^{st} layer | BW (osy) | 0.5 | 1 | 1 | 0.75 | 0.5 | 1 |
| | Visil ® | 40 | 40 | 40 | 40 | 40 | 40 |
| | Modacrylic | 40 | 40 | 40 | 40 | 40 | 40 |
| | binder | 20 | 20 | 20 | 20 | 20 | 20 |
| 2^{nd} layer | BW (osy) | 4 | 3 | 4 | 3 | 3 | 3 |
| | Cotton | 100 | 100 | 100 | 100 | 100 | 100 |
| 3^{rd} layer | BW (osy) | 0.5 | 1 | 1 | 0.75 | 1 | 0.5 |
| | Visil ® | 40 | 40 | 40 | 40 | 40 | 40 |
| | Modacrylic | 40 | 40 | 40 | 40 | 40 | 40 |
| | binder | 20 | 20 | 20 | 20 | 20 | 20 |
| | Total BW (osy) | 5 | 5 | 6 | 4.5 | 4.5 | 4.5 |
| | Final | 384 | 299 | 315 | 381 | 352 | 346 |
| | Temperature | | | | | | |
| | (° C.) | | | | | | |

### Example 6

The procedure of Example 4 was repeated to obtain additional TPT results except the fire blocking fabric structures had an additional heat absorber layer attached to the outer surface of one of the fire barrier layers. The results are shown as items 15-21 in Table 4. The resulting fire blocking fabric structures had a total basis weight of from 7 to 12 ounces per square yard. All of these items had TPT temperatures of less than 400° C., which is believed to be critical for passage of TB 603.

### Example 7

The procedure of Example 5 was repeated to obtain additional TPT results except the fire blocking fabric structures had an additional heat absorber layer attached to the outer surface of one of the fire barrier layers. The results are shown as items 22-29 in Table 5. The resulting in fire blocking fabric structures having a total basis weight of from 7.5 to 12 ounces per square yard. In addition, the two heat absorber layers in Items 22-28 were the cotton disclosed in Example 5, while the two heat absorber layers of Item 29 were FR PET spunbonded sheets as prepared and described in Example 3.

All of these items had TPT temperatures of less than 400° C., which is believed to be critical for passage of TB 603.

TABLE 4

| | Item | 15 | 16 | 17 | 18 | 19 | 20 | 21 |
|---|---|---|---|---|---|---|---|---|
| 1^{st} layer | BW (osy)¹ | 0.5 | 0.5 | 1 | 1 | 0.75 | 0.5 | 1 |
| | Visil ®² | 37.5 | 37.5 | 37.5 | 37.5 | 37.5 | 37.5 | 37.5 |
| | Kevlar ®³ | 37.5 | 37.5 | 37.5 | 37.5 | 37.5 | 37.5 | 37.5 |
| | binder² | 25 | 25 | 25 | 25 | 25 | 25 | 25 |
| 2^{nd} layer | BW (osy) | 3 | 5 | 3 | 5 | 3 | 3 | 5 |
| | Cotton⁴ | 100 | 100 | 100 | 100 | 100 | 100 | 100 |
| 3^{rd} layer | BW (osy) | 0.5 | 0.5 | 1 | 1 | 0.75 | 1 | 0.5 |
| | Visil | 37.5 | 37.5 | 37.5 | 37.5 | 37.5 | 37.5 | 37.5 |
| | Kevlar | 37.5 | 37.5 | 37.5 | 37.5 | 37.5 | 37.5 | 37.5 |
| | binder | 25 | 25 | 25 | 25 | 25 | 25 | 25 |
| 4^{th} layer | BW (osy) | 3 | 5 | 3 | 5 | 3 | 3 | 5 |
| | Cotton | 100 | 100 | 100 | 100 | 100 | 100 | 100 |
| | Total BW (osy) | 7 | 11 | 8 | 12 | 7.5 | 7.5 | 11.5 |
| | Final Temperature (° C.) | 305 | 220 | 231 | 213 | 249 | 276 | 289 |

TABLE 5

| | Item | 22 | 23 | 24 | 25 | 26 | 27 | 28 | 29 |
|---|---|---|---|---|---|---|---|---|---|
| 1^{st} layer | BW (osy) | 0.5 | 1 | 1 | 0.75 | 0.5 | 1 | 2 | 2 |
| | Visil ® | 40 | 40 | 40 | 40 | 40 | 40 | 40 | 40 |
| | Modacrylic | 40 | 40 | 40 | 40 | 40 | 40 | 40 | 40 |
| | binder | 20 | 20 | 20 | 20 | 20 | 20 | 20 | 20 |
| 2^{nd} layer | BW (osy) | 4 | 3 | 4 | 3 | 3 | 3 | 4 | 2 |
| | FR PET | 0 | 0 | 0 | 0 | 0 | 0 | 0 | 100 |
| | Cotton | 100 | 100 | 100 | 100 | 100 | 100 | 100 | 0 |
| 3^{rd} layer | BW (osy) | 0.5 | 1 | 1 | 0.75 | 1 | 0.5 | 2 | 2 |
| | Visil ® | 40 | 40 | 40 | 40 | 40 | 40 | 40 | 40 |
| | Modacrylic | 40 | 40 | 40 | 40 | 40 | 40 | 40 | 40 |
| | binder | 20 | 20 | 20 | 20 | 20 | 20 | 20 | 20 |
| 4^{th} layer | BW (osy) | 4 | 3 | 4 | 3 | 3 | 3 | 4 | 2 |
| | FR PET | 0 | 0 | 0 | 0 | 0 | 0 | 0 | 100 |
| | Cotton | 100 | 100 | 100 | 100 | 100 | 100 | 100 | 0 |
| | Total BW (osy) | 9 | 8 | 10 | 7.5 | 7.5 | 7.5 | 12 | 8 |
| | Final Temperature (° C.) | 208 | 247 | 210 | 291 | 237 | 296 | 174 | 303 |

What is claimed is:

1. A fire blocking structure, useful in at least a part of a mattress construction, comprising, in order:
(a) an fire impingement face of a first fire barrier having a basis weight of at least 0.5 ounces per square yard and comprising at least one structural char-forming staple fiber, (b) a first heat absorber containing substantially no structural char-forming staple fiber, (c) a second fire barrier comprising at least one structural char-forming staple fiber, and optionally, ‘(d) a second heat absorber containing substantially no structural char-forming staple fiber,
wherein the ratio of the total basis weight of the fire barrier in the structure to the total basis weight of the heat absorber in the structure is from 1:6 to 1:1;
wherein the structural char-forming staple fiber is a cellulosic fiber that retains at least 10 percent of its fiber weight when heated in air to 700° C. at a rate of 20 degrees C. per minute; and
wherein less that 25 percent of the fire blocking structure surface area has open cracks and gaps through the structure after impingement of the structure with a 2 cal/cm²/second (8.38 J/cm²/second) heat flux imposed on the fabric for 90 seconds, and
after impingement the amount of open cracks and gaps through the structure is less than that experienced by a structure having a fire impingement face of a single fire barrier having the same total weight of the first and second fire barrier combined and a single heat absorber having the same total weight of the first and optional second heat absorber combined, when impinged by an identical heat flux.

2. The fireblocking structure of claim 1 wherein less than 15 percent of the structure area has open cracks and gaps through the structure after impingement of the heat flux.

3. The fireblocking structure of claim 1 wherein less than 5 percent of the structure surface area has open cracks and gaps through the structure after impingement of the heat flux.

4. The fireblocking structure of claim 1 having a Thermal Performance Temperature (TPT) of less than 400° C.

5. The fireblocking structure of claim 1 wherein the total basis weight of the fireblocking structure is from 4 to 12 ounces per square yard.

6. The fireblocking structure of claim 1 wherein the first or second fire barrier comprises multiple layers.

7. The fireblocking structure of claim 1 wherein the first or optional second heat absorber comprises multiple layers.

8. The fireblocking structure of claim 1, wherein the cellulose fiber is a viscose fiber containing hydrated silicon dioxide in the form of a polysilicic acid with aluminum silicate sites.

9. The fireblocking structure of claim 1, wherein the first or second fire barrier further comprises para-aramid fiber.

10. The fireblocking structure of claim 9, wherein the para-aramid fiber is poly(paraphenylene terephthalamide).

11. The fireblocking structure of claim 1, wherein the first or second fire barrier further comprises an organic fiber made from a polymer selected from the group consisting of polybenzazole, polybenzimidazole, and polyimide polymer.

12. The fireblocking structure of claim 1, wherein the first or optional second heat absorber comprises cotton fiber.

13. The fireblocking structure of claim 1, wherein the first or optional second heat absorber comprises flame retardant polyester fiber.

14. An article comprising the fireblocking structure of claim 1.

15. A mattress comprising the fireblocking structure of claim 1.

16. A process for making a fireblocking structure comprising:
a) arranging, in order,
(i) a first fire barrier fabric, comprising one or more layers and having a basis weight of at least 0.5 ounces per square yard and comprising at least one structural char-forming staple fiber,
(ii) a first heat absorber, comprising one or more layers and containing substantially no structural char-forming staple fiber,
(iii) a second fire barrier fabric, comprising one or more layers and comprising least one structural char-forming staple fiber, and
(iv) optionally, a second heat absorber, comprising one or more layers and containing substantially no structural char-forming staple fiber,
wherein the ratio of the total basis weight of the fire barrier fabric in the structure to the total basis weight of the heat absorber in the structure is from1:6 to 1:1, and
wherein the structural char-forming staple fiber is a cellulosic fiber that retains at least 1 0 percent of its fiber weight when heated in air to 700° C. at a rate of 20 degrees C. per minute, and
b) attaching the layers together to form a fabric structure.

17. The process of claim 16 wherein one or more layers in the structure are attached to each other with an adhesive.

18. The process of claim 16 wherein one or more layers in the structure are attached to each other via stitching.

19. The process of claim 18 wherein the stitching is accomplished with fire-retardant thread.

20. The process of claim 16 wherein one or more layers in the structure are attached via thermal bonding.
